(19) United States
(12) Patent Application Publication
(10) Pub. No.: US 2019/0180383 A1
(43) Pub. Date: Jun. 13, 2019

(54) METHOD AND SYSTEM FOR AUTOMATED SUBMISSION OF TAXATION INFORMATION

(71) Applicant: Mastercard International Incorporated, Purchase, NY (US)

(72) Inventors: Andrew REISKIND, Armonk, NY (US); Rohit CHAUHAN, Somers, NY (US); Serge BERNARD, Ridgefield, CT (US); Jean-Pierre GERARD, Croton-On-Hudson, NY (US)

(73) Assignee: Mastercard International Incorporated, Purchase, NY (US)

(21) Appl. No.: 15/837,164

(22) Filed: Dec. 11, 2017

(51) Int. Cl. G06Q 40/00; G06Q 20/12

(52) U.S. Cl. CPC G06Q 40/123; G06Q 20/12

(57) ABSTRACT

A method for automated payment of tax for payment transactions includes: receiving transaction messages related to payment transactions involving a merchant including a transaction amount and a merchant identifier; identifying a tax authority having jurisdiction over each payment transaction; identifying a tax amount for each of the plurality of transaction messages based on the transaction amount stored in the respective transaction message; identifying a tax identification number for the merchant based on the transaction messages; and initiating settlement of a settlement amount to a transaction account associated with the merchant, wherein the settlement amount is based on a combination of the transaction amounts included in each of the plurality of transaction messages less a combination of the identified tax amounts for the at least one tax authorities for each of the plurality of transaction messages.

### FIELD

The present disclosure relates to the automated reporting of and payment of taxation for payment transactions, specifically the automated parsing of data from processed payment transactions and use thereof to withhold payment of tax during settlement and reporting thereof to appropriate agencies.

### BACKGROUND

In many jurisdictions, sales tax is charged for every transaction that a merchant participates in. The sales tax must be collected, accounted for, and eventually paid to the appropriate authority. In addition to the payment of sales tax, the taxation authority may often require the merchant to regularly provide reports on their transactions, the associated taxes, and tax payments made by the merchant. In some cases, there may be more than one taxation authority to which the merchant must pay and/or report, there may be more than one type of tax to be paid and/or reported on by the merchant, or a combination thereof. For many merchants, especially small businesses that may be unfamiliar with taxation reporting, such processes may be difficult and cumbersome for merchants to deal with.

Currently, there are services that may be utilized by merchants to assist in the reporting and payment of taxes. In some cases, a merchant may provide all of their sales information to a service provider that may calculate the necessary taxes and prepare the reports on behalf of the merchant for a fee. In other cases, a software program may be utilized by a merchant that may accept all of the merchant's transaction information as input, and may calculate necessary taxes and prepare the reports for payment and submission to the relevant authority, respectively.

However, these services all require the merchant to provide transaction information after settlement of the transaction, where the merchant has already received the full transaction amount for the transaction. The service then calculates the tax amount(s) to be paid, which is then paid by the merchant. As a result, the merchant has received payment from their customers, after which a portion of the collected amount has to be deducted and paid out to any relevant authorities. This can lead to difficulties for a merchant to identify what portion of their account they may use without adversely affecting their ability to pay taxes. Thus, there is a need for a technological solution to provide for automated payment and reporting of taxation for a merchant to improve merchant operations and efficiency.

### SUMMARY

The present disclosure provides a description of systems and methods for the automated payment and reporting of tax for payment transactions. Tax amounts for each transaction are identified as the transaction is processed, where payment of the tax is performed automatically during the settlement of the transaction, enabling a merchant to have their tax paid without ever receiving the money from their customer, increasing the accuracy of the merchant's accounting with respect to the amount they have available for use, and reducing the first hand management of tax that needs to be done by the merchant. In addition, the reporting of the tax to the appropriate authority may also be automated, to further reduce the management that must be performed by the merchant, increasing their operating efficiency.

A method for automated payment of tax for payment transactions includes: receiving, by a receiving device of a processing server, a plurality of transaction messages, wherein each transaction message is a structured data set formatted based on one or more standards that is related to a payment transaction involving a merchant and includes at least a plurality of data elements including at least a first data element configured to store a transaction amount and a second data element configured to store a merchant identifier associated with the involved merchant; identifying, by a data identification module of the processing server, at least one tax authority having jurisdiction over each payment transaction based on the received plurality of transaction messages; identifying, by the data identification module of the processing server, a tax amount for each of the at least one tax authorities for each of the plurality of transaction messages based on at least the transaction amount stored in first data element included in the respective transaction message; identifying, by the data identification module of the processing server, a tax identification number for the merchant based on the received plurality of transaction messages; and initiating, by a transaction processing module of the processing server, settlement of a settlement amount to a transaction account associated with the merchant, wherein the settlement amount is based on at least a combination of the transaction amounts included in each of the plurality of transaction messages less a combination of the identified tax amounts for each of the at least one tax authorities for each of the plurality of transaction messages.

A method for automated submission of tax data for payment transactions includes: receiving, by a receiving device of a processing server, a plurality of transaction messages, wherein each transaction message is a structured data set formatted based on one or more standards that is related to a payment transaction involving a merchant and includes at least a plurality of data elements including at least a first data element configured to store a transaction amount and a second data element configured to store a merchant identifier associated with the involved merchant; identifying, by a data identification module of the processing server, at least one tax authority having jurisdiction over each payment transaction based on the received plurality of transaction messages; identifying, by the data identification module of the processing server, a tax amount for each of the at least one tax authorities for each of the plurality of transaction messages based on at least the transaction amount stored in first data element included in the respective transaction message; identifying, by the data identification module of the processing server, a tax identification number for the merchant based on the received plurality of transaction messages; generating, by a reporting module of the processing server, at least one tax report for each of the at least one tax authorities, wherein the tax report includes at least the identified tax amounts for the respective tax authority and the identified tax identification number; and electronically transmitting, by a transmitting device of the processing server, the generated at least one tax report for each of the at least one tax authorities to the respective tax authority.

A system for automated payment of tax for payment transactions includes: a receiving device of a processing server configured to receive a plurality of transaction messages, wherein each transaction message is a structured data set formatted based on one or more standards that is related to a payment transaction involving a merchant and includes at least a plurality of data elements including at least a first data element configured to store a transaction amount and a second data element configured to store a merchant identifier associated with the involved merchant; a data identification module of the processing server configured to identify at least one tax authority having jurisdiction over each payment transaction based on the received plurality of transaction messages, identify a tax amount for each of the at least one tax authorities for each of the plurality of transaction messages based on at least the transaction amount stored in first data element included in the respective transaction message, and identify a tax identification number for the merchant based on the received plurality of transaction messages; and a transaction processing module of the processing server configured to initiate settlement of a settlement amount to a transaction account associated with the merchant, wherein the settlement amount is based on at least a combination of the transaction amounts included in each of the plurality of transaction messages less a combination of the identified tax amounts for each of the at least one tax authorities for each of the plurality of transaction messages.

A system for automated submission of tax data for payment transactions includes: a receiving device of a processing server configured to receive a plurality of transaction messages, wherein each transaction message is a structured data set formatted based on one or more standards that is related to a payment transaction involving a merchant and includes at least a plurality of data elements including at least a first data element configured to store a transaction amount and a second data element configured to store a merchant identifier associated with the involved merchant; a data identification module of the processing server configured to identify at least one tax authority having jurisdiction over each payment transaction based on the received plurality of transaction messages, identify a tax amount for each of the at least one tax authorities for each of the plurality of transaction messages based on at least the transaction amount stored in first data element included in the respective transaction message, and identify a tax identification number for the merchant based on the received plurality of transaction messages; a reporting module of the processing server configured to generate at least one tax report for each of the at least one tax authorities, wherein the tax report includes at least the identified tax amounts for the respective tax authority and the identified tax identification number; and a transmitting device of the processing server configured to electronically transmit the generated at least one tax report for each of the at least one tax authorities to the respective tax authority.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for the automated payment and reporting of tax for payment transactions in accordance with exemplary embodiments.

FIG. 2 is a block diagram illustrating the processing server of the system of FIG. 1 for the automated reporting and payment of tax in accordance with exemplary embodiments.

FIG. 3 is a flow diagram illustrating a process for automated reporting and payment of tax using the processing server of FIG. 2 in accordance with exemplary embodiments.

FIG. 4 is a flow chart illustrating an exemplary method for automated payment of tax for payment transactions in accordance with exemplary embodiments.

FIG. 5 is a flow chart illustrating an exemplary method for automated submission of tax data for payment transactions in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Automated Payment and Reporting of Tax

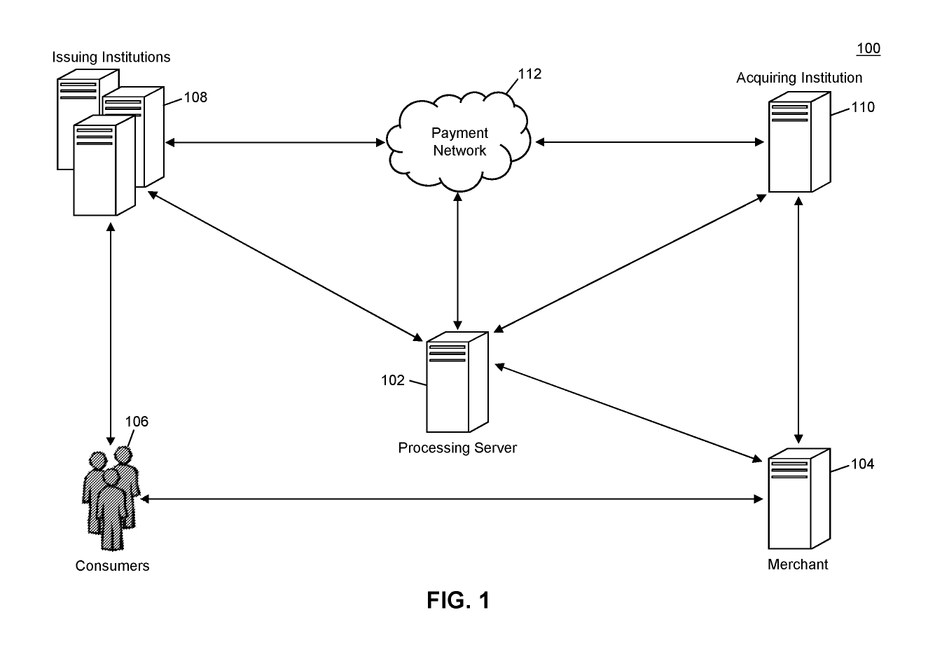

FIG. 1 illustrates a system 100 for the automated payment of taxes and reporting of data associated therewith to appropriate taxation authorities for a merchant.

The system 100 may include a processing server 102. The processing server 102, discussed in more detail below, may be configured to automatically identify tax amounts to be paid by a merchant 104 to relevant taxing authorities during the processing of payment transactions prior to settlement thereof, as well as automatically generate reports that are to be submitted to the relevant taxing authorities by the merchant 104. In the system 100, the merchant 104 may be involved in a plurality of payment transactions with various consumers 106, on which tax must be paid and one or more reports generated.

Each consumer 106 may utilize a transaction account to fund the payment transaction involving the merchant 104. Transaction accounts may be issued to the consumers 106 for use thereby by one or more issuing institutions 106. The issuing institutions 106 may be financial institutions, such as issuing banks, or other entities configured to issue transaction accounts for use in funding payment transactions. The issuing institutions 108 may provision payment credentials to their consumers 106, which may be presented to the merchant 104 as part of the initiation of a payment transaction therewith. The merchant 104 may receive the payment credentials, which may be submitted to an acquiring institution 110 as part of the processing of a payment transaction. The acquiring institution 110 may be a financial institution, such as an acquiring bank, or other suitable entity configured to issue a transaction account to the merchant 104 for use in receiving funds as part of the processing of payment transaction. Transaction data for a payment transaction may be directly submitted to the acquiring institution 110 by the merchant 104 (e.g., via a point of sale system thereof) or via one or more intermediate entities, such as a gateway processor.

The acquiring institution 110 may receive the transaction data for each payment transaction, which may be submitted to a payment network 112 via payment rails associated therewith for processing. Transaction data may be incorporated into transaction messages that are submitted to the payment network 112 for processing. A transaction message may be a specially formatted data message that is formatted pursuant to one or more standards governing the exchange of financial transaction messages, such as the International Organization of Standardization's ISO 8583 or ISO 20022 standards. In some embodiments, the transaction message may be generated by the acquiring institution 110 based on the transaction data submitted by the merchant 104. In other embodiments, the transaction message may be generated by the merchant 104 and submitted to the acquiring institution 110 for forwarding to the payment network.

Each transaction message may include a message type indicator indicative of a type of transaction message (e.g., authorization request, authorization response, clearing message, etc.), as well as a plurality of data elements, where each data element is configured to store transaction data. In some cases, a transaction message may further include one or more bitmaps, where each bitmap may indicate the data elements included in the transaction message and the data stored therein. Transaction data that may be stored in the data elements included in the transaction message may include at least one of transaction amount, currency type, product data (e.g., product name, product cost, product identifier, etc.), transaction time, transaction date, geographic location, merchant identifier, tax identification number, tax amount, etc. The payment network 112 may receive the transaction message, and may seek approval of the payment transaction from the issuing institution 108 associated with the transaction account that is to be used to fund the payment transaction, which may approve or deny the payment transaction using traditional methods.

If a payment transaction is approved, the payment network 112 may forward a transaction message associated therewith (e.g., the authorization request as submitted by the acquiring institution 110 or an authorization response provided by the issuing institution 110) to the processing server 102. In some embodiments, the processing server 102 may be external to the payment network 112 and receive the transaction message via the payment rails associated therewith or an alternative communication method. In other embodiments, the processing server 102 may be a part of the payment network 112 and may receive the transaction message via an internal communication network, or may receive the transaction message directly from the acquiring institution 110 and/or issuing institution 108.

The processing server 102 may be configured to identify one or more tax authorities to whom tax must be paid and/or reported to by the merchant 104. In one embodiment, one or more data elements included in the transaction message may indicate a tax authority (e.g., as identified by the merchant 104 and/or acquiring institution 110 during generation of the transaction message). In another embodiment, the processing server 102 may be configured to identify one or more tax authorities based on a geographic location stored in a corresponding data element included in the transaction message, such as based on the jurisdiction that includes the geographic location. In yet another embodiment, the processing server 102 may possess a lookup table that stores tax authorities associated with the merchant 104 via a merchant identifier or other identifying information parsed from the transaction message.

The processing server 102 may then identify at least one tax amount for each applicable tax authority. Tax amounts may include, for instance, sales tax, use tax, import/export tax, ad valorem type tax, cross border tax, etc. In one embodiment, the tax amount(s) may be stored in one or more data elements included in the transaction message (e.g., as identified by the merchant 104 and/or acquiring institution 110 during generation of the transaction message). In another embodiment, the processing server 102 may calculate the tax amount(s) based on tax regulations for the applicable tax authorities and the transaction amount and/or product costs stored in corresponding data elements included in the transaction message. For example, in some cases, tax may be different for different product categories, which may, in such cases, require the processing server 102 to be supplied with the tax cost for each product or the product cost and a product category for the products being purchased. In some such cases, product cost data may be provided directly by the merchant 104 (e.g., in the transaction message), or may be identified by the processing server 102 (e.g., via a lookup table) based on data stored in the transaction message, such as using product identifiers (e.g., universal product codes, stock-keeping units, European article numbers, etc.) supplied by the merchant 104.

The processing server 102 may also be configured to identify a tax identification number for the merchant 104. In one embodiment, the tax identification number may be stored in a data element included in the transaction message (e.g., as identified by the merchant 104 and/or acquiring institution 110 during generation of the transaction message). In another embodiment, the processing server 102 may be configured to identify the tax identification number in a lookup table, where the tax identification number may be associated with information identifying the merchant 104 that may be parsed from the transaction message. For instance, a data element included in the transaction message may store a merchant identification number, merchant name, or other identifying information that may be used by the processing server 102 in identifying the tax identification number.

For the automation of payment of tax, once the processing server 102 identifies the appropriate information, the processing server 102 may instruct the payment network 112 to subtract the tax amount from the payment transaction, such that settlement of the payment transaction ensures that the merchant's transaction account is credited for the transaction amount less the taxes to be paid. In some cases, the payment network 112 may separately initiate settlement of the tax amount to the appropriate tax authority or authorities from the issuing institutions 108. In some instances, the payment network 112 may settle the transaction using traditional processes, but may immediately initiate a payment transaction for payment of the tax amount from the merchant's transaction account to the relevant tax authority or authorities, such that the tax amount will be withdrawn from the merchant's transaction account prior to posting of the credit for the payment transaction. As a result, the system 100 may provide for automated payment of taxes on behalf of a merchant 104, where the taxes may be paid directly to the taxing authority as part of the settlement of a payment transaction, ensuring that the tax authority receives tax as the payment transactions occur, and providing the merchant 104 with a clearer accounting of their transaction account as no amount needs to be set aside for taxes.

In some embodiments, the processing server 102 may also, or alternatively, be configured to automatically generate reports for submission to tax authorities. In such embodiments, the processing server 102 may identify the applicable tax authorities for a payment transaction, the corresponding tax amount(s), and the merchant's tax identification number, as discussed above. The processing server 102 may be configured to generate reports suitable for each of the applicable tax authorities (e.g., a Form 1099 for the Internal Revenue Service in the United States) using the information included in the received transaction messages and parsed therefrom. The processing server 102 may receive data from tax authorities indicating the data that must be reported, such as electronic forms to be filled out by the processing server 102, data fields that are required, etc. The processing server 102 may prepare the appropriate reporting documents using the merchant's tax identification number and data obtained using the methods discussed herein. In some embodiments, the processing server 102 may submit the reports directly to the applicable tax authorities on behalf of the merchant 104. In other embodiments, the processing server 102 may provide the reports to the merchant 104 and/or acquiring institution 110 for forwarding to the applicable tax authority. In some cases, the processing server 102 may contact one or more additional entities (e.g., issuing institutions 108) to collect additional data for use in the reports. As a result, the system 100 may provide for automated reporting to tax authorities, further improving the operating efficiency of merchants 104. In addition, because the processing server 102 receives transaction data in real-time, reports may be prepared and submitted to tax authorities more quickly and efficiently than using existing systems, which may provide greater efficiency to tax authorities as well as merchants 104 using the processing discussed herein.

### Processing Server

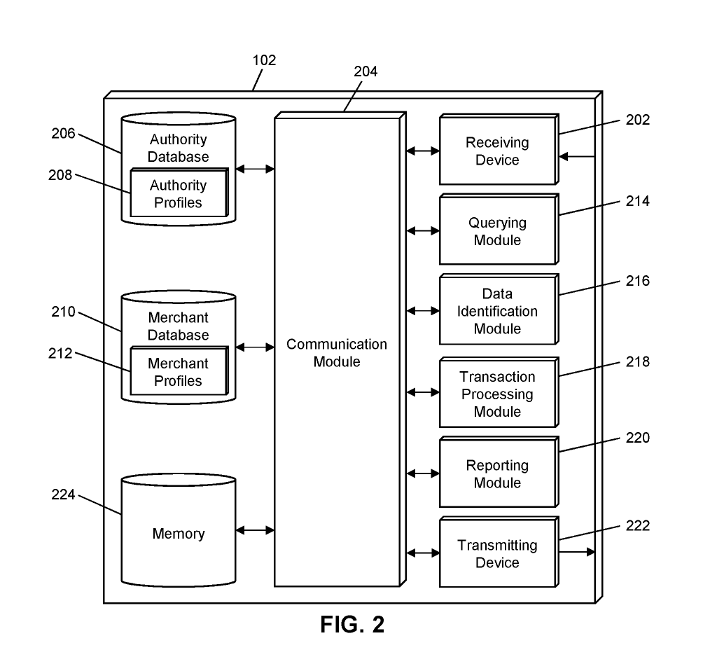

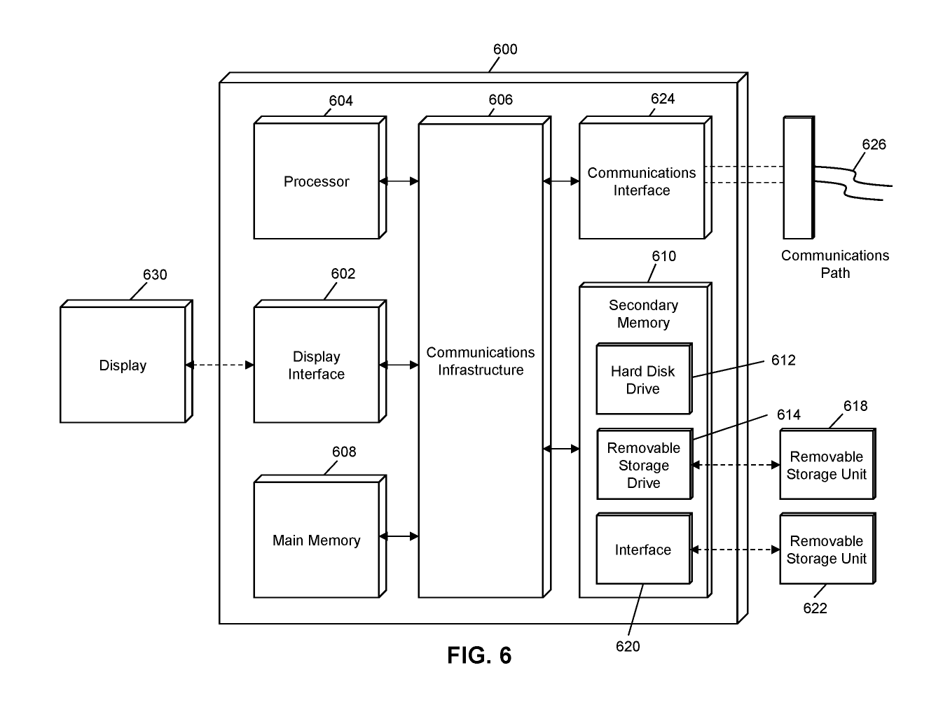

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 600 illustrated in FIG. 6 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from merchants 104, issuing institutions 108, acquiring institutions 110, payment networks 112, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by issuing institutions 108, acquiring institutions 110, and/or payment networks 112, which may be superimposed or otherwise encoded with transaction messages, which may include data elements configured to store at least a transaction amount, merchant identifier, and other transaction data. The receiving device 202 may also be configured to receive data signals electronically transmitted by merchants 104, which may be superimposed or otherwise encoded with data for use in generating and submitting tax reports, such as a tax identification number, merchant identifying information, merchant address, etc. The receiving device 202 may also be configured to receive data signals electronically transmitted by tax authorities, which may be superimposed or otherwise encoded with tax reports or data associated therewith for use in the preparation and submission of tax reports.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 214, data identification module 216, transaction processing module 218, reporting module 220, etc. As used herein, the term “module” may be software or hardware particularly programmed to receive an input, perform one or more processes using the input, and provides an output. The input, output, and processes performed by various modules will be apparent to one skilled in the art based upon the present disclosure.

In some embodiments, the processing server 102 may include an authority database 206. The authority database 206 may be configured to store a plurality of authority profiles 208 using a suitable data storage format and schema. The authority database 206 may be a relational database that utilizes structured query language for the storage, identification, modifying, updating, accessing, etc. of structured data sets stored therein. Each authority profile 208 may be a structured data set configured to store data related to a tax authority. The authority profile 208 may include tax rates, reporting requirements, and other data that may be used by the processing server 102 in generating reports for submission to the related tax authority as well as the automated payment of taxes thereto.

The processing server 102 may also include a merchant database 210. The merchant database 210 may be configured to store a plurality of merchant profiles 212 using a suitable data storage format and schema. The merchant database 210 may be a relational database that utilizes structured query language for the storage, identification, modifying, updating, accessing, etc. of structured data sets stored therein. Each merchant profile 212 may be a structured data set configured to store data related to a merchant, such as the merchant 104 in the system 100. The merchant profile 212 may be configured to store at least a merchant identifier, which may be one or more values that unique identify the related merchant 104. The merchant profile 212 may also include additional information suitable for performing the functions discussed herein, such as a geographic location, applicable tax authorities, transaction account details, communication data for transmitting communications to the merchant 104, etc.

The processing server 102 may include a querying module 214. The querying module 214 may be configured to execute queries on databases to identify information. The querying module 214 may receive one or more data values or query strings, and may execute a query string based thereon on an indicated database, such as the authority database 206, to identify information stored therein. The querying module 214 may then output the identified information to an appropriate engine or module of the processing server 102 as necessary. The querying module 214 may, for example, execute a query on the authority database 206 to identify an authority profile 208 stored therein based on a geographic location parsed from a transaction message to identify tax authorities whose jurisdiction includes a processed payment transaction, for the automated payment and/or reporting of tax thereto.

The processing server 102 may also include a data identification module 216. The data identification module 216 may be configured to identify data for use by the processing server 102 in performing the functions discussed herein. The data identification module 216 may receive an instruction as input, may identify data as instructed, and may output the identified data to another module or engine of the processing server 102. The data identification module 216 may, for instance, identify data stored in data elements included in a received transaction message, or may use data identified therefrom in the generation of a query submitted to the querying module 214 for execution on the authority database 206 or merchant database 210 to identify data as instructed. For example, the data identification module 216 may be configured to identify tax amounts, tax identification numbers, tax authorities, reporting data, etc.

The processing server 102 may also include a transaction processing module 218. The transaction processing module 218 may be configured to perform functions of the processing server 102 related to the initiation and processing of electronic payment transactions, as will be apparent to persons having skill in the relevant art. The transaction processing module 218 may be configured to, for example, modify transaction messages to reduce transaction amounts based on identified tax amounts, initiate payment transactions for the payment of tax following a processed payment transaction, etc.

The processing server 102 may also include a reporting module 220. The reporting module 220 may be configured to generate reports for use by the processing server 102 in performing the functions discussed herein. The reporting module 220 may receive a request for a report as input, may generate the report as requested, and may output the report to another module or engine of the processing server 102. In some instances, the input to the reporting module 220 may include data for inclusion in the report or to identify data to be included in the report. In other instances, the reporting module 220 may be configured to identify such data, such as by utilizing the querying module 214 to identify data stored in an authority profile 208. The reporting module 220 may be configured to generate tax reports for payment transactions involving a merchant 104 for one or more tax authorities for submission thereto.

The processing server 102 may also include a transmitting device 222. The transmitting device 222 may be configured to transmit data over one or more networks via one or more network protocols. In some instances, the transmitting device 222 may be configured to transmit data to merchants 104, payment networks 112, and other entities via one or more communication methods, local area networks, wireless area networks, cellular communication, Bluetooth, radio frequency, the Internet, etc. In some embodiments, the transmitting device 222 may be comprised of multiple devices, such as different transmitting devices for transmitting data over different networks, such as a first transmitting device for transmitting data over a local area network and a second transmitting device for transmitting data via the Internet. The transmitting device 222 may electronically transmit data signals that have data superimposed that may be parsed by a receiving computing device. In some instances, the transmitting device 222 may include one or more modules for superimposing, encoding, or otherwise formatting data into data signals suitable for transmission.

The transmitting device 222 may be configured to electronically transmit data signals to merchants 104 that are superimposed or otherwise encoded with reports generated by the reporting module 220 for forwarding to relevant tax authorities. The transmitting device 222 may also be configured to electronically transmit data signals to payment networks 112, which may be superimposed or otherwise encoded with modified or newly generated transaction messages for use in automated payment of tax by a merchant 104, which may include the withholding of tax in a processed payment transaction or the initiation of a secondary payment transaction for payment of tax upon processing of a first payment transaction. In some embodiments, the transmitting device 222 may be configured to electronically transmit data signals to tax authorities that are superimposed or otherwise encoded with reports generated based on transaction data on behalf of a merchant 104.

The processing server 102 may also include a memory 224. The memory 224 may be configured to store data for use by the processing server 102 in performing the functions discussed herein, such as public and private keys, symmetric keys, etc. The memory 224 may be configured to store data using suitable data formatting methods and schema and may be any suitable type of memory, such as read-only memory, random access memory, etc. The memory 224 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 224 may be comprised of or may otherwise include a relational database that utilizes structured query language for the storage, identification, modifying, updating, accessing, etc. of structured data sets stored therein.

### Process for Automated Payment and Reporting of Tax

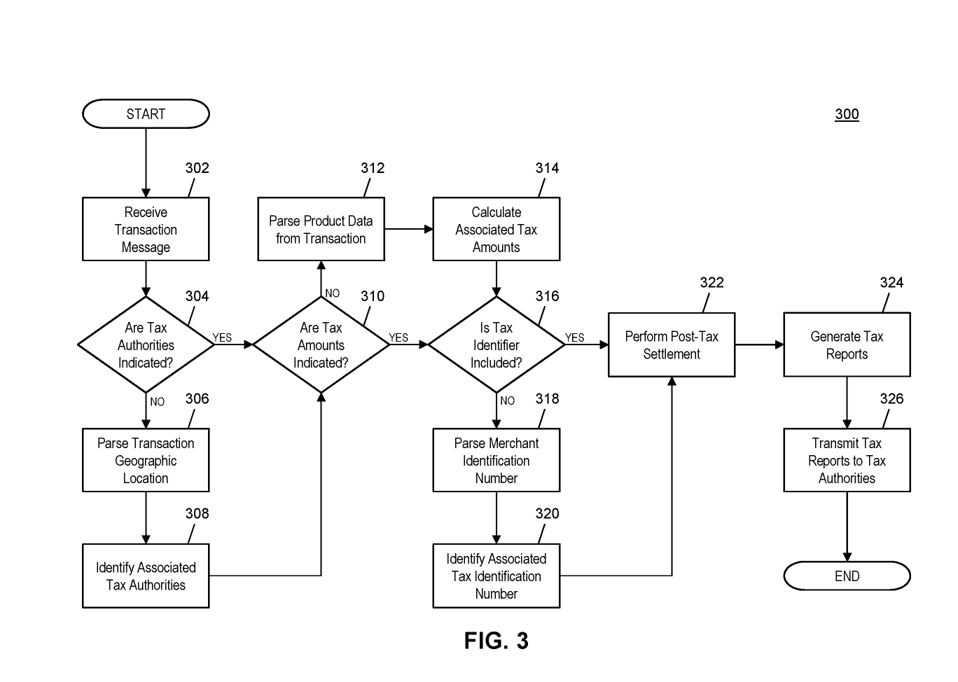

FIG. 3 illustrates a process executed by the processing server 102 in the system 100 for the automated payment of tax for payment transactions involving a merchant 104 and the reporting thereof to relevant tax authorities.

In step 302, the receiving device 202 of the processing server 102 may receive a transaction message for a payment transaction involving the merchant 104. The transaction message may be formatted pursuant to one or more standards and include a plurality of data elements configured to store at least a transaction amount and a merchant identifier. In step 304, the data identification module 216 of the processing server 102 may determine if the transaction message includes identifiers of tax authorities to which the payment transaction must comply. If the transaction message does identify the applicable tax authorities, then the process 300 may proceed to step 310. If not, then, in step 308, the data identification module 216 may identify a geographic location stored in a corresponding data element included in the transaction message to identify the jurisdiction in which the transaction was conducted. In step 308, the querying module 214 of the processing server 102 may execute a query on the authority database 206 of the processing server 102 to identify one or more authority profiles 208 that include data indicating jurisdictional applicability to the geographic location, for identification of the tax authorities related thereto.

Once the tax authorities are identified, then, in step 310, the data identification module 216 may determine if tax amounts paid by for the transaction are stored in a data element included in the transaction message. If tax amounts are identified in the transaction message, then the process 300 may proceed to step 316. If no tax amounts are identified, or an insufficient number of tax amounts (e.g., missing one or more taxes for one or more authorities), then, in step 312, the data identification module 216 of the processing server 102 may parse product data from one or more data elements included in the transaction message. In step 314, the transaction processing module 218 of the processing server 102 may calculate the necessary tax amounts based on at least the product cost for each product as included in the product data, which may also be further based on additional criteria as applicable to the tax and the tax authority, such as product category, geographic location, etc.

Once the tax amounts are identified, then, in step 316, the data identification module 216 may determine if a tax identifier (e.g., tax identification number) associated with the merchant 104 is included in the transaction message. If a tax identifier is provided, then the process 300 may proceed to step 322. If the transaction message does not include a tax identifier, then, in step 318, the data identification module 216 may parse the data elements included in the transaction message to identify a merchant identification number or other merchant identifying information stored therein. In step 320, the querying module 214 of the processing server 102 may execute a query on the merchant database 210 to identify a merchant profile 212 based on the identifying information, and may identify a tax identification number associated with the merchant 104 as stored therein.

In step 322, the transaction processing module 218 of the processing server 102 may perform settlement of the payment transaction. In one embodiment, settlement may include payment of the full transaction amount from the applicable issuing institution 108 to the acquiring institution 110 for crediting of the merchant's transaction account, with a second transaction initiated for payment of the tax amount from the merchant's transaction account to the applicable tax authorities. In another embodiment, the settlement may be performed by crediting the merchant's transaction account for the transaction amount less the tax amount, and the settlement of the tax amount to the applicable tax authorities. In step 324, the reporting module 220 of the processing server 102 may generate at least one tax report for each applicable tax authority in connection with any standards or regulations associated therewith. In step 326, the transmitting device 222 of the processing server 102 may electronically transmit the generated reports to the applicable tax authorities using suitable communication networks and methods.

### Exemplary Method for Automated Payment of Tax

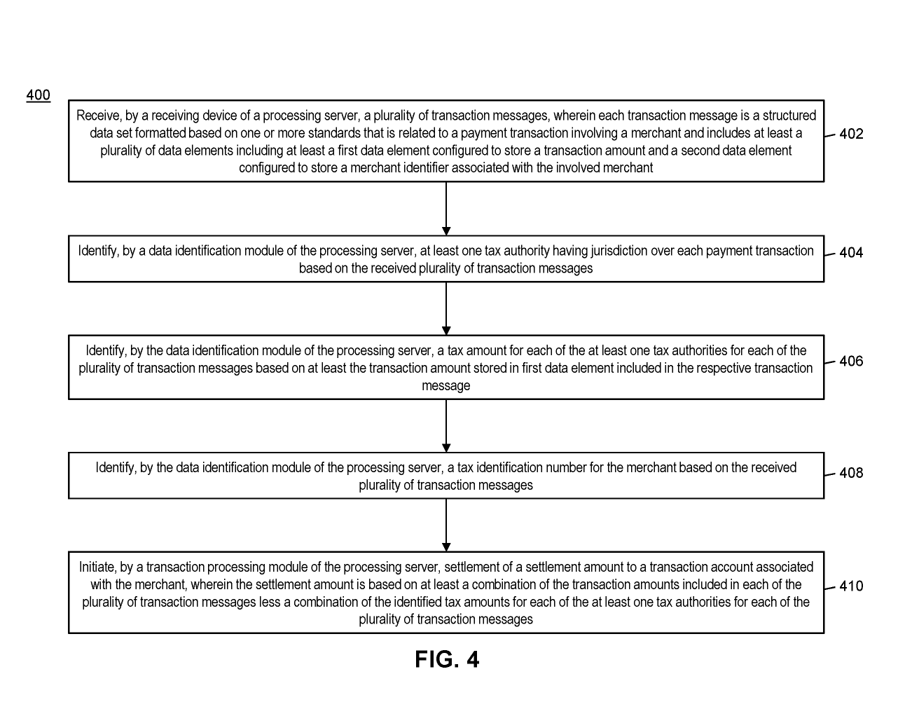

FIG. 4 illustrates a method 400 for the automated payment of tax in a payment transaction.

In step 402, a plurality of transaction messages may be received by a receiving device (e.g., the receiving device 202) of a processing server (e.g., the processing server 102), wherein each transaction message is a structured data set formatted based on one or more standards that is related to a payment transaction involving a merchant (e.g., the merchant 104) and includes at least a plurality of data elements including at least a first data element configured to store a transaction amount and a second data element configured to store a merchant identifier associated with the involved merchant. In step 404, at least one tax authority having jurisdiction over each payment transaction may be identified by a data identification module (e.g., the data identification module 216) of the processing server based on the received plurality of transaction messages.

In step 406, a tax amount may be identified for each of the at least one tax authorities for each of the plurality of transaction messages by the data identification module of the processing server based on at least the transaction amount stored in first data element included in the respective transaction message. In step 408, a tax identification number may be identified by the data identification module of the processing server 102 for the merchant based on the received plurality of transaction messages. In step 410, a settlement of a settlement amount to a transaction account associated with the merchant may be initiated by a transaction processing module (e.g., the transaction processing module 218) of the processing server, wherein the settlement amount is based on at least a combination of the transaction amounts included in each of the plurality of transaction messages less a combination of the identified tax amounts for each of the at least one tax authorities for each of the plurality of transaction messages.

In one embodiment, each of the at least one tax authorities may be indicated in a data element configured for private use included in each of the plurality of transaction messages. In some embodiments, each of the plurality of transaction messages may further includes a third data element configured to store a geographic location, and identification of each of the at least one tax authorities may be further based on the geographic location included in each of the plurality of transaction messages. In a further embodiment, the method 400 may further include storing, in an authority database (e.g., the authority database 206) of the processing server, a plurality of authority profiles (e.g., authority profiles 208), wherein each authority profiles is a structured data set related to a tax authority and includes at least an associated geographic location, wherein identification of each of the at least one tax authorities further includes executing, by a querying module (e.g., the querying module 214) of the processing server, a query on the authority database to identify at least one authority profile where the included associated geographic location corresponds to the geographic location included in the plurality of transaction messages.

In one embodiment, the tax amount for each of the at least one tax authorities for each of the plurality of transaction messages may be stored in at least one additional data element configured for private use included in the respective transaction message. In some embodiments, each of the plurality of transaction messages may further include at least one additional data element configured to store product data related to products purchased in the corresponding payment transaction including at least a product cost, and the tax amount for each of the at least one tax authorities for each of the plurality of transaction messages may be further based on the product cost included in the product data stored in the respective transaction message.

In one embodiment, the tax identification number may be stored in an additional data element included in each of the plurality of transaction messages. In some embodiments, the method 400 may further include storing, in a merchant database (e.g., the merchant database 210) of the processing server, a merchant profile (e.g., merchant profile 212), wherein the merchant profile includes a structured data set related to the merchant and includes at least the merchant identifier and the tax identification number, wherein identification of the tax identification number includes executing, by a querying module of the processing server, a query on the merchant database to identify the merchant profile based on the merchant identifier stored in the second data element included in the plurality of transaction messages.

### Exemplary Method for Automated Submission of Tax Data

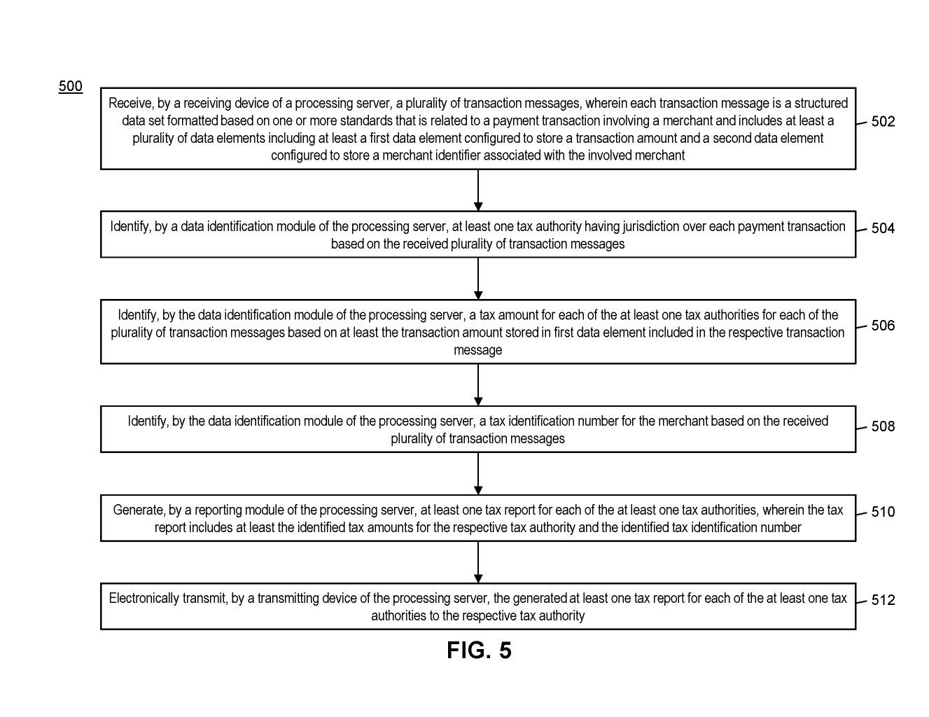

FIG. 5 illustrates a method 500 for the automated submission of tax data to applicable tax authorities for a payment transaction.

In step 502, a plurality of transaction messages may be received by a receiving device (e.g., the receiving device 202) of a processing server (e.g., the processing server 102), wherein each transaction message is a structured data set formatted based on one or more standards that is related to a payment transaction involving a merchant (e.g., the merchant 104) and includes at least a plurality of data elements including at least a first data element configured to store a transaction amount and a second data element configured to store a merchant identifier associated with the involved merchant. In step 504, at least one tax authority having jurisdiction over each payment transaction may be identified by a data identification module (e.g., the data identification module 216) of the processing server based on the received plurality of transaction messages.

In step 506, a tax amount may be identified for each of the at least one tax authorities for each of the plurality of transaction messages by the data identification module of the processing server based on at least the transaction amount stored in first data element included in the respective transaction message. In step 508, a tax identification number may be identified by the data identification module of the processing server 102 for the merchant based on the received plurality of transaction messages.

In step 510, at least one tax report may be generated for each of the at least one tax authorities by a reporting module (e.g., the reporting module 220) of the processing server, wherein the tax report includes at least the identified tax amounts for the respective tax authority and the identified tax identification number. In step 512, the generated at least one tax report for each of the at least one tax authorities may be electronically transmitted by a transmitting device (e.g., the transmitting device 222) of the processing server to the respective tax authority.

In one embodiment, each of the at least one tax authorities may be indicated in a data element configured for private use included in each of the plurality of transaction messages. In some embodiments, each of the plurality of transaction messages may further include a third data element configured to store a geographic location, and identification of each of the at least one tax authorities may be further based on the geographic location included in each of the plurality of transaction messages. In one embodiment, the method 500 may further include storing, in an authority database (e.g., the authority database 206) of the processing server, a plurality of authority profiles (e.g., authority profiles 208), wherein each authority profiles is a structured data set related to a tax authority and includes at least an associated geographic location, wherein identification of each of the at least one tax authorities further includes executing, by a querying module (e.g., the querying module 214) of the processing server, a query on the authority database to identify at least one authority profile where the included associated geographic location corresponds to the geographic location included in the plurality of transaction messages.

In some embodiments, the tax amount for each of the at least one tax authorities for each of the plurality of transaction messages may be stored in at least one additional data element configured for private use included in the respective transaction message. In one embodiment, each of the plurality of transaction messages may further include at least one additional data element configured to store product data related to products purchased in the corresponding payment transaction including at least a product cost, and the tax amount for each of the at least one tax authorities for each of the plurality of transaction messages may be further based on the product cost included in the product data stored in the respective transaction message.

In some embodiments, the tax identification number may be stored in an additional data element included in each of the plurality of transaction messages. In one embodiment, the method 500 may also include storing, in a merchant database (e.g., the merchant database 210) of the processing server, a merchant profile (e.g., merchant profile 212), wherein the merchant profile includes a structured data set related to the merchant and includes at least the merchant identifier and the tax identification number, wherein identification of the tax identification number includes executing, by a querying module of the processing server, a query on the merchant database to identify the merchant profile based on the merchant identifier stored in the second data element included in the plurality of transaction messages.

### Computer System Architecture

FIG. 6 illustrates a computer system 600 in which embodiments of the present disclosure, or portions thereof, may be implemented as computer-readable code. For example, the processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device specifically configured to perform the functions discussed herein. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3-5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

The processor device 604 may comprise one or more modules or engines configured to perform the functions of the computer system 600. Each of the modules or engines may be implemented using hardware and, in some instances, may also utilize software, such as corresponding to program code and/or programs stored in the main memory 608 or secondary memory 610. In such instances, program code may be compiled by the processor device 604 (e.g., by a compiling module or engine) prior to execution by the hardware of the computer system 600. For example, the program code may be source code written in a programming language that is translated into a lower level language, such as assembly language or machine code, for execution by the processor device 604 and/or any additional hardware components of the computer system 600. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

Techniques consistent with the present disclosure provide, among other features, systems and methods for automated payment and submission of tax data for payment transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for automated payment of tax for payment transactions, comprising:
receiving, by a receiving device of a processing server, a plurality of transaction messages, wherein each transaction message is a structured data set formatted based on one or more standards that is related to a payment transaction involving a merchant and includes at least a plurality of data elements including at least a first data element configured to store a transaction amount and a second data element configured to store a merchant identifier associated with the involved merchant;
identifying, by a data identification module of the processing server, at least one tax authority having jurisdiction over each payment transaction based on the received plurality of transaction messages;
identifying, by the data identification module of the processing server, a tax amount for each of the at least one tax authorities for each of the plurality of transaction messages based on at least the transaction amount stored in first data element included in the respective transaction message;
identifying, by the data identification module of the processing server, a tax identification number for the merchant based on the received plurality of transaction messages; and
initiating, by a transaction processing module of the processing server, settlement of a settlement amount to a transaction account associated with the merchant, wherein the settlement amount is based on at least a combination of the transaction amounts included in each of the plurality of transaction messages less a combination of the identified tax amounts for each of the at least one tax authorities for each of the plurality of transaction messages.

2. The method of claim 1, wherein each of the at least one tax authorities is indicated in a data element configured for private use included in each of the plurality of transaction messages.

3. The method of claim 1, wherein
each of the plurality of transaction messages further includes a third data element configured to store a geographic location, and
identification of each of the at least one tax authorities is further based on the geographic location included in each of the plurality of transaction messages.

4. The method of claim 3, further comprising:
storing, in an authority database of the processing server, a plurality of authority profiles, wherein each authority profiles is a structured data set related to a tax authority and includes at least an associated geographic location, wherein
identification of each of the at least one tax authorities further includes executing, by a querying module of the processing server, a query on the authority database to identify at least one authority profile where the included associated geographic location corresponds to the geographic location included in the plurality of transaction messages.

5. The method of claim 1, wherein the tax amount for each of the at least one tax authorities for each of the plurality of transaction messages is stored in at least one additional data element configured for private use included in the respective transaction message.

6. The method of claim 1, wherein
each of the plurality of transaction messages further includes at least one additional data element configured to store product data related to products purchased in the corresponding payment transaction including at least a product cost, and
the tax amount for each of the at least one tax authorities for each of the plurality of transaction messages is further based on the product cost included in the product data stored in the respective transaction message.

7. The method of claim 1, wherein the tax identification number is stored in an additional data element included in each of the plurality of transaction messages.

8. The method of claim 1, further comprising:
storing, in a merchant database of the processing server, a merchant profile, wherein the merchant profile includes a structured data set related to the merchant and includes at least the merchant identifier and the tax identification number, wherein
identification of the tax identification number includes executing, by a querying module of the processing server, a query on the merchant database to identify the merchant profile based on the merchant identifier stored in the second data element included in the plurality of transaction messages.

9. A method for automated submission of tax data for payment transactions, comprising:
receiving, by a receiving device of a processing server, a plurality of transaction messages, wherein each transaction message is a structured data set formatted based on one or more standards that is related to a payment transaction involving a merchant and includes at least a plurality of data elements including at least a first data element configured to store a transaction amount and a second data element configured to store a merchant identifier associated with the involved merchant;
identifying, by a data identification module of the processing server, at least one tax authority having jurisdiction over each payment transaction based on the received plurality of transaction messages;
identifying, by the data identification module of the processing server, a tax amount for each of the at least one tax authorities for each of the plurality of transaction messages based on at least the transaction amount stored in first data element included in the respective transaction message;
identifying, by the data identification module of the processing server, a tax identification number for the merchant based on the received plurality of transaction messages;
generating, by a reporting module of the processing server, at least one tax report for each of the at least one tax authorities, wherein the tax report includes at least the identified tax amounts for the respective tax authority and the identified tax identification number; and
electronically transmitting, by a transmitting device of the processing server, the generated at least one tax report for each of the at least one tax authorities to the respective tax authority.

10. The method of claim 9, wherein each of the at least one tax authorities is indicated in a data element configured for private use included in each of the plurality of transaction messages.

11. The method of claim 9, wherein
each of the plurality of transaction messages further includes a third data element configured to store a geographic location, and
identification of each of the at least one tax authorities is further based on the geographic location included in each of the plurality of transaction messages.

12. The method of claim 11, further comprising:
storing, in an authority database of the processing server, a plurality of authority profiles, wherein each authority profiles is a structured data set related to a tax authority and includes at least an associated geographic location, wherein
identification of each of the at least one tax authorities further includes executing, by a querying module of the processing server, a query on the authority database to identify at least one authority profile where the included associated geographic location corresponds to the geographic location included in the plurality of transaction messages.

13. The method of claim 9, wherein the tax amount for each of the at least one tax authorities for each of the plurality of transaction messages is stored in at least one additional data element configured for private use included in the respective transaction message.

14. The method of claim 9, wherein
each of the plurality of transaction messages further includes at least one additional data element configured to store product data related to products purchased in the corresponding payment transaction including at least a product cost, and
the tax amount for each of the at least one tax authorities for each of the plurality of transaction messages is further based on the product cost included in the product data stored in the respective transaction message.

15. The method of claim 9, wherein the tax identification number is stored in an additional data element included in each of the plurality of transaction messages.

16. The method of claim 9, further comprising:
storing, in a merchant database of the processing server, a merchant profile, wherein the merchant profile includes a structured data set related to the merchant and includes at least the merchant identifier and the tax identification number, wherein
identification of the tax identification number includes executing, by a querying module of the processing server, a query on the merchant database to identify the merchant profile based on the merchant identifier stored in the second data element included in the plurality of transaction messages.

17. A system for automated payment of tax for payment transactions, comprising:
a receiving device of a processing server configured to receive a plurality of transaction messages, wherein each transaction message is a structured data set formatted based on one or more standards that is related to a payment transaction involving a merchant and includes at least a plurality of data elements including at least a first data element configured to store a transaction amount and a second data element configured to store a merchant identifier associated with the involved merchant;
a data identification module of the processing server configured to
identify at least one tax authority having jurisdiction over each payment transaction based on the received plurality of transaction messages,
identify a tax amount for each of the at least one tax authorities for each of the plurality of transaction messages based on at least the transaction amount stored in first data element included in the respective transaction message, and
identify a tax identification number for the merchant based on the received plurality of transaction messages; and
a transaction processing module of the processing server configured to initiate settlement of a settlement amount to a transaction account associated with the merchant, wherein the settlement amount is based on at least a combination of the transaction amounts included in each of the plurality of transaction messages less a combination of the identified tax amounts for each of the at least one tax authorities for each of the plurality of transaction messages.

18. The system of claim 17, wherein each of the at least one tax authorities is indicated in a data element configured for private use included in each of the plurality of transaction messages.

19. The system of claim 17, wherein
each of the plurality of transaction messages further includes a third data element configured to store a geographic location, and
identification of each of the at least one tax authorities is further based on the geographic location included in each of the plurality of transaction messages.

20. The system of claim 19, further comprising:
an authority database of the processing server configured to store a plurality of authority profiles, wherein each authority profiles is a structured data set related to a tax authority and includes at least an associated geographic location, wherein
identification of each of the at least one tax authorities further includes executing, by a querying module of the processing server, a query on the authority database to identify at least one authority profile where the included associated geographic location corresponds to the geographic location included in the plurality of transaction messages.

21. The system of claim 17, wherein the tax amount for each of the at least one tax authorities for each of the plurality of transaction messages is stored in at least one additional data element configured for private use included in the respective transaction message.

22. The system of claim 17, wherein
each of the plurality of transaction messages further includes at least one additional data element configured to store product data related to products purchased in the corresponding payment transaction including at least a product cost, and
the tax amount for each of the at least one tax authorities for each of the plurality of transaction messages is further based on the product cost included in the product data stored in the respective transaction message.

23. The system of claim 17, wherein the tax identification number is stored in an additional data element included in each of the plurality of transaction messages.

24. The system of claim 17, further comprising:
a merchant database of the processing server configured to store a merchant profile, wherein the merchant profile includes a structured data set related to the merchant and includes at least the merchant identifier and the tax identification number, wherein
identification of the tax identification number includes executing, by a querying module of the processing server, a query on the merchant database to identify the merchant profile based on the merchant identifier stored in the second data element included in the plurality of transaction messages.

25. A system for automated submission of tax data for payment transactions, comprising:
a receiving device of a processing server configured to receive a plurality of transaction messages, wherein each transaction message is a structured data set formatted based on one or more standards that is related to a payment transaction involving a merchant and includes at least a plurality of data elements including at least a first data element configured to store a transaction amount and a second data element configured to store a merchant identifier associated with the involved merchant;
a data identification module of the processing server configured to
identify at least one tax authority having jurisdiction over each payment transaction based on the received plurality of transaction messages,
identify a tax amount for each of the at least one tax authorities for each of the plurality of transaction messages based on at least the transaction amount stored in first data element included in the respective transaction message, and
identify a tax identification number for the merchant based on the received plurality of transaction messages;
a reporting module of the processing server configured to generate at least one tax report for each of the at least one tax authorities, wherein the tax report includes at least the identified tax amounts for the respective tax authority and the identified tax identification number; and
a transmitting device of the processing server configured to electronically transmit the generated at least one tax report for each of the at least one tax authorities to the respective tax authority.

26. The system of claim 25, wherein each of the at least one tax authorities is indicated in a data element configured for private use included in each of the plurality of transaction messages.

27. The system of claim 25, wherein
each of the plurality of transaction messages further includes a third data element configured to store a geographic location, and
identification of each of the at least one tax authorities is further based on the geographic location included in each of the plurality of transaction messages.

28. The system of claim 27, further comprising:
an authority database of the processing server configured to store a plurality of authority profiles, wherein each authority profiles is a structured data set related to a tax authority and includes at least an associated geographic location, wherein
identification of each of the at least one tax authorities further includes executing, by a querying module of the processing server, a query on the authority database to identify at least one authority profile where the included associated geographic location corresponds to the geographic location included in the plurality of transaction messages.

29. The system of claim 25, wherein the tax amount for each of the at least one tax authorities for each of the plurality of transaction messages is stored in at least one additional data element configured for private use included in the respective transaction message.

30. The system of claim 25, wherein
each of the plurality of transaction messages further includes at least one additional data element configured to store product data related to products purchased in the corresponding payment transaction including at least a product cost, and
the tax amount for each of the at least one tax authorities for each of the plurality of transaction messages is further based on the product cost included in the product data stored in the respective transaction message.

31. The system of claim 25, wherein the tax identification number is stored in an additional data element included in each of the plurality of transaction messages.

32. The system of claim 25, further comprising:
a merchant database of the processing server configured to store a merchant profile, wherein the merchant profile includes a structured data set related to the merchant and includes at least the merchant identifier and the tax identification number, wherein
identification of the tax identification number includes executing, by a querying module of the processing server, a query on the merchant database to identify the merchant profile based on the merchant identifier stored in the second data element included in the plurality of transaction messages.
